(19) United States
(12) Patent Application Publication
(10) Pub. No.: US 2015/0360864 A1
(43) Pub. Date: Dec. 17, 2015

(54) Movable Trashcan

(71) Applicant: Donald M. Mullally, Yorba Linda, CA (US)

(72) Inventor: Donald M. Mullally, Yorba Linda, CA (US)

(21) Appl. No.: 14/307,432

(22) Filed: Jun. 17, 2014

(51) Int. Cl. B65F 1/14

(52) U.S. Cl. CPC B65F 1/1473; B65F 1/1452; B65F 1/1646

(57) ABSTRACT

A movable trashcan of the present invention is equipped with a set of casters attached to its bottom and an adjustable stop that ensures its stability when motionless. The trashcan has an extendable, telescopic handle that allows it to be readily moved in substantially upright position. The container has a lid with hinges that ensure easy open and shut capability. A lid component is attached to the extendable handle so that the entire lid lifts up to clear top of the container for easy retrieval of the trash bag for disposal. The trashcan is intended to make garbage relocation and disposal easier for elderly and disabled persons in particular.

### BACKGROUND OF THE INVENTION

1. Field of the Invention

The present invention relates to a field of trashcans, more specifically to household trashcans that can be readily moved or transported from one location to another. The trashcan of the present invention is to be located indoors as a receptacle for household or office garbage but it can be easily moved outside or to another location where garbage is collected.

2. Description of Related Art

A variety of trashcans and carts for trashcan relocation are known in the prior art. Most of them are stationary trashcans that require bending, lifting, and carrying when one needs to change their location or movable receptacles that involve one bending over to push them. Other inventions include carts intended mostly for heavy and tall outdoor trash receptacles. These solutions, however, do not address the needs of the elderly and disabled who require means for moving smaller trash quantities from its regular indoor location, whether it is a kitchen or a home office, to an outdoor or another space where bulk trash receptacles are positioned with limited effort and without much exertion and strain on their back and joints. Therefore, an unfulfilled need for such a household trash container still exists.

### SUMMARY OF THE INVENTION

The trashcan of the present invention is a movable household garbage can that can be readily transported in a substantially upright position from one location to another. In an exemplary embodiment of the present invention, there is disclosed a trashcan equipped with a set of casters attached to its bottom and an adjustable stop that ensures its stability when motionless. The trashcan has a handle that can be extended to move it from one place to another for permanent garbage disposal. To contain spread of garbage odor the container has a lid with a set of hinges that ensure easy open and shut capability. A lid component is attached to the extendable handle so that the entire lid lifts up to clear top of the container to allow easy retrieval of the trash bag for disposal. The trashcan is designed to make garbage relocation and disposal easier for elderly and disabled persons in particular.

The more important features of the invention have thus been outlined in order that the more detailed description that follows may be better understood and in order that the present contribution to the art may better be appreciated. Additional features of the invention will be described hereinafter and will form the subject matter of the claims that follow. It is to be understood, however, that the invention is not limited in its application to the details of construction and the arrangements of the components set forth in the following description or illustrated in the drawings. It is capable of other embodiments and of being practiced and carried out in various ways. Also it is to be understood that the phraseology and terminology employed herein are for the purpose of description and should not be regarded as limiting.

### BRIEF DESCRIPTION OF THE DRAWINGS

Different aspects, features, and advantages of the present invention will become more fully apparent from the following detailed description, the appended claim, and the accompanying drawings in which similar elements are given similar reference numerals.

FIG. 1 is a side view of the trashcan with lid open and extended handle

FIG. 2 is a top view of the trashcan

FIG. 3 is a perspective view of the trashcan with extended handle and lid raised

FIG. 4 is a side view of the trashcan with extended handle and lid raised

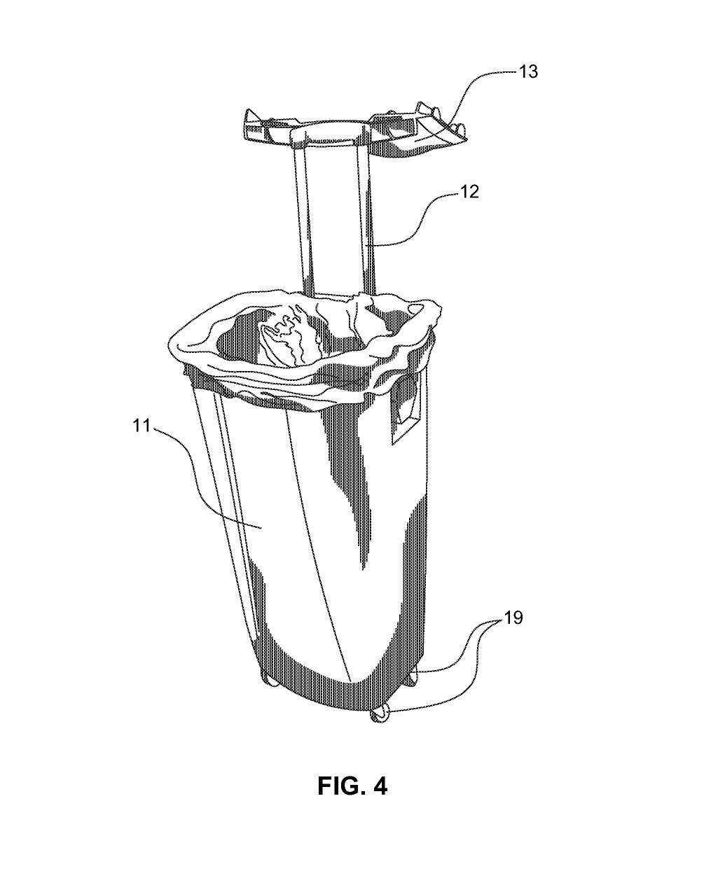

FIG. 5 is a perspective view of the bottom of trashcan turned upside down

FIG. 6 is a view of the bottom of the trashcan

FIG. 7 is a side view of the trashcan turned upside down

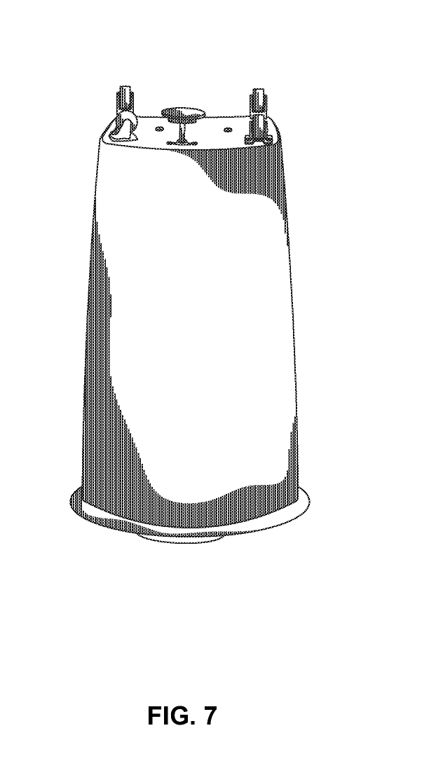

### DESCRIPTION OF THE PREFERRED EMBODIMENT

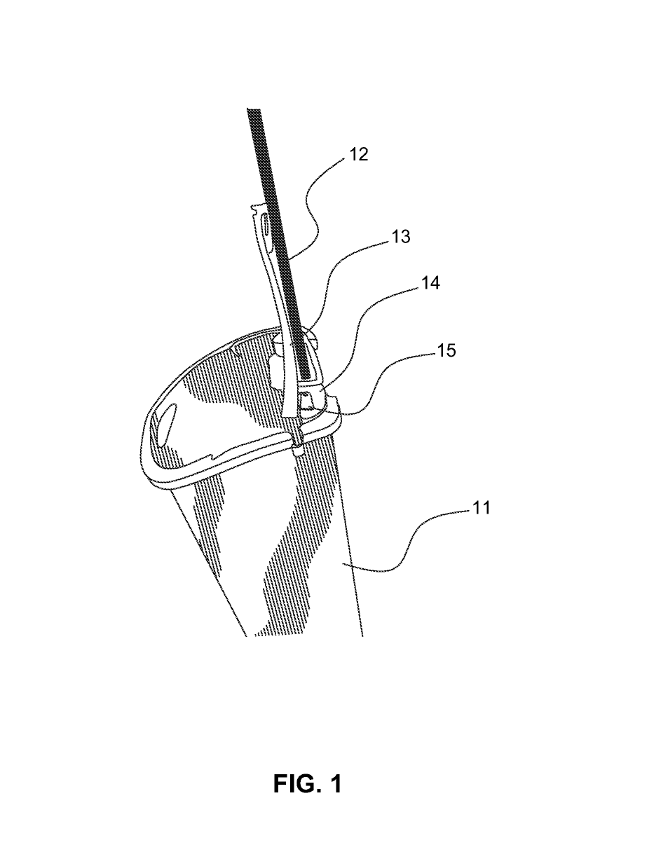

Referring to FIG. 1, there is disclosed a trashcan having a trash container 11, an extendable handle 12 and a lid 13 that can be open and remain affixed to its rear section 14 via, at a minimum, one hinge 15.

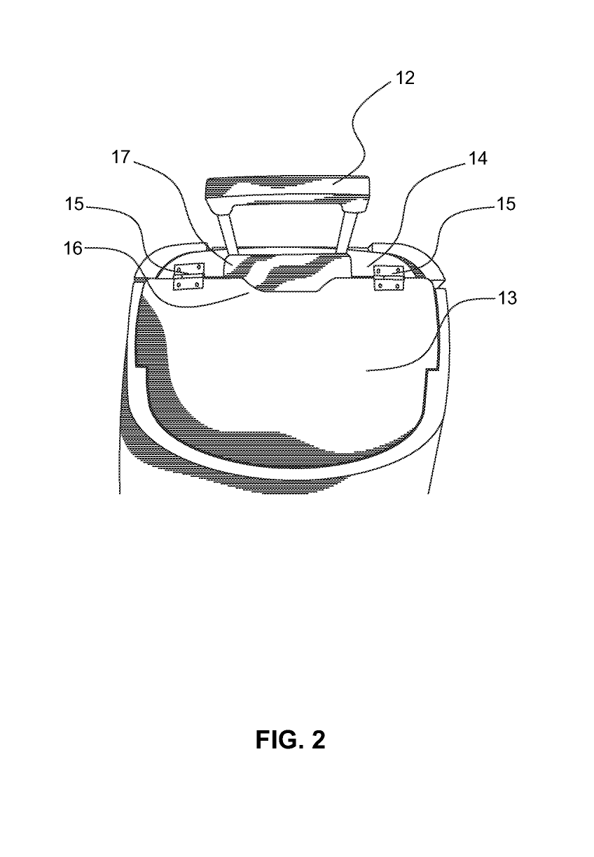

FIG. 2 shows top view of said trashcan with lid 13 closed and handle 12 extended. The trashcan lid 13 has an opening 16 shaped to accommodate the top bracket 17 that holds the extendable handle 12 in place.

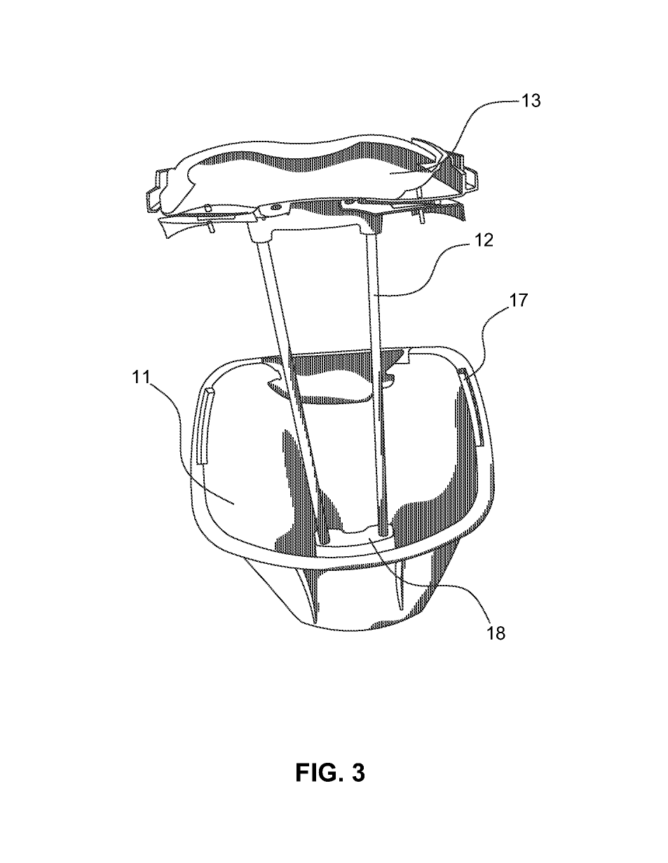

As in FIG. 3, a second bracket 18 affixed to the bottom of the trashcan or in close proximity to it provides another point of support for handle 12. The figure also shows that lid 13 can be lifted up extended handle 12 and affixed on top of it to facilitate removal of a filled trash bag and insertion of a new one. Casters 19 are affixed to the bottom 20 of the trashcan container 11.

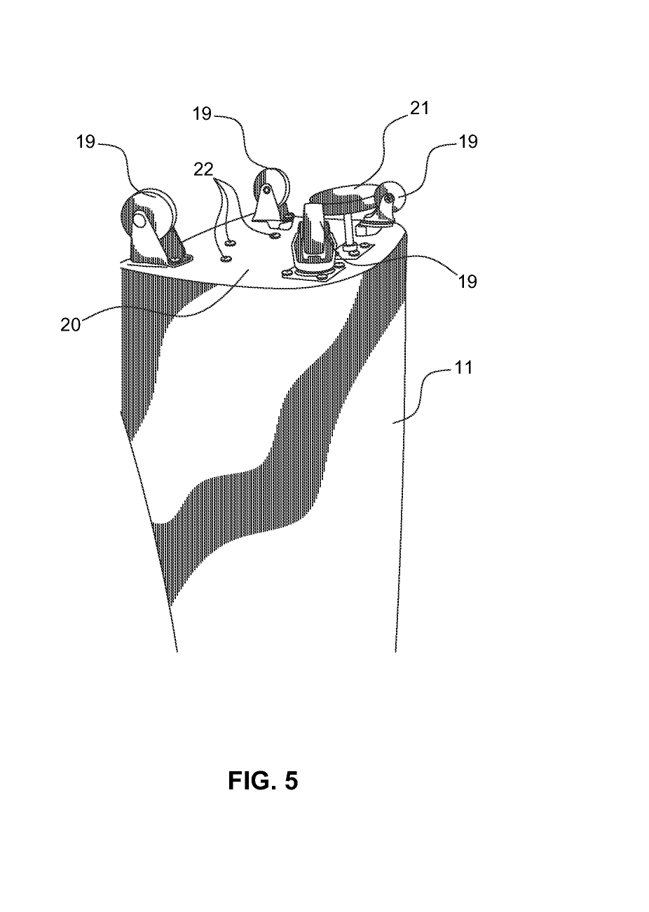

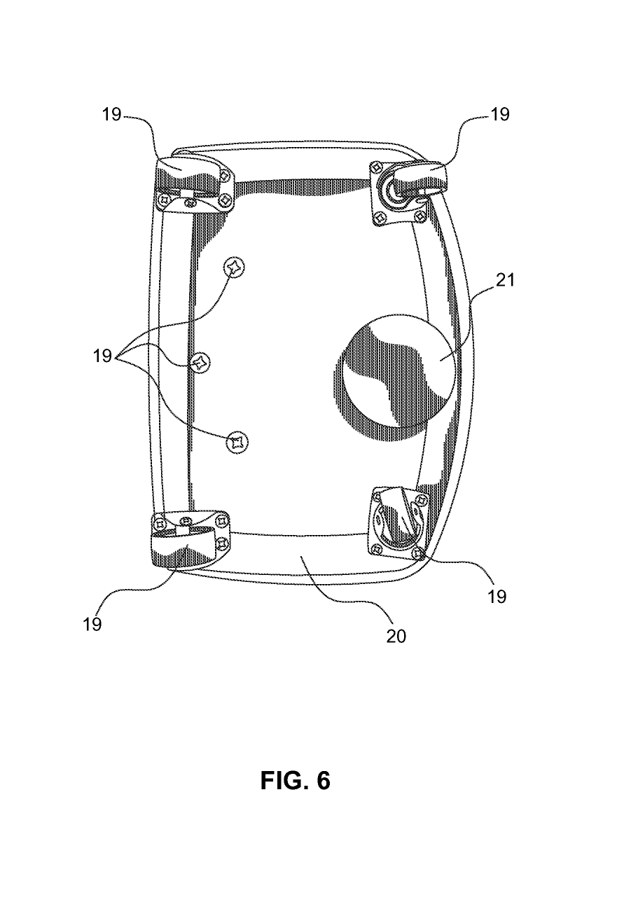

FIGS. 5 and 6 depict four casters 19 and an adjustable stop 21 attached to the bottom 20 of the trashcan. Three screws 22 seen at the bottom 20 affix the second handle bracket 18 (not visible here) to the trashcan. While casters 19 allow for easy transfer of the trashcan from one place to another, adjustable stop 21 provides stability whenever the trashcan remains stationary.

The figures show a trashcan equipped with four casters and one stop but a combination of a different number of casters and stoppers is also envisioned. As few as two casters and two stoppers, three casters and two stoppers, or other combination thereof can also be used. Other rolling elements that could provide trashcan mobility are also within the scope of the invention of the invention.

The trashcan handle is designed to extend so that persons of different heights, even the disabled and elderly, can adjust its length to be able to comfortably pull and move the trashcan from one location to another with one hand. The extendable handle of the preferred embodiment has telescopic structure allowing it to be extended to desired length whenever the trashcan is to be moved and pushed back down when not needed. However, this embodiment does not limit the scope of the present invention as other handle construction such as folding, recoiling or elastic handles or those involving a spring or other mechanisms that allow handle extension and folding are also meant to be part of the disclosure.

The trashcan container can be manufactured from plastic by injection molding, from a composite, metal or from other lightweight materials using techniques known in the art. The extendable handle can also be made out of plastic, a lightweight metal such as the ones used in luggage handle construction or equivalent sturdy material. The brackets that serve to affix the handle to the container can be manufactured separately and affixed to the container with a strong adhesive, screws, welding or another method known in the art, or they can be made an integral part of the container using injection molding technique or other methods known in the art and suitable for materials used in the manufacturing process.

While there have been shown and described and pointed out the fundamental novel features of the invention as applied to the preferred embodiments, it will be understood that the foregoing is considered as illustrative only of the principles of the invention and not intended to be exhaustive or to limit the invention to the precise forms disclosed. Obvious modifications or variations are possible in light of the above teachings.

What is claimed is:

1. A trashcan comprising:
A container having a lid, an extendable handle, an immobilizing member and plurality of casters affixed thereto;
Said extendable handle having capacity to be substantially masked in its collapsed state and substantially extended when pulled on, and said handle being affixed to said container via, at a minimum, one bracket member;
Said immobilizing member being located at the bottom of said container and providing stability thereto; and
Said casters being affixed to said trashcan so it can be readily moved from one location to another.

2. A trashcan of claim 1 wherein said extendable handle is telescopic.

3. A trashcan of claim 1 wherein said extendable handle is affixed to the outer surface of said container.

4. A trashcan of claim 1 wherein said extendable handle is affixed to the inner surface of said container.

5. A trashcan comprising:
A container having an extendable handle, an immobilizing member and plurality of casters affixed thereto and said container having also a removable lid;
Said handle having capacity to be substantially hidden in its collapsed state and substantially extended when pulled on, and said handle being affixed to said container inner surface via, at a minimum, one bracket member;
Said lid having substantially larger front section and substantially smaller rear section attached to one another with, at a minimum, one flex member, and said lid having an opening accommodating top section of said bracket of said extendable handle;
Said bracket top section fitting substantially closely the shape of said lid opening;
Said immobilizing member being located at the bottom of said container and providing stability thereto; and
Said wheels being affixed to said trashcan so it can be readily moved from one location to another.

6. A trashcan of claim 5 wherein said extendable handle is telescopic.

7. A trashcan of claim 5 wherein said lid flex element is a hinge.
